(19) United States
(12) Patent Application Publication
(10) Pub. No.: US 2005/0259109 A1
(43) Pub. Date: Nov. 24, 2005

(54) System and method for a gamut mapping platform having plug-in transform functions

(75) Inventor: Michael Stokes, Eagle, ID (US)

Correspondence Address: SHOOK, HARDY & BACON L.L.P., 2555 GRAND BOULEVARD, KANSAS CITY, MO, 64108-2613, US

(73) Assignee: Microsoft Corporation, Redmond, WA (US)

(21) Appl. No.: 10/848,070

(22) Filed: May 19, 2004

(51) Int. Cl. G09G 5/02

(52) U.S. Cl. 345/590

(57) ABSTRACT

A system and related techniques enhance the gamut mapping from input devices, such as cameras, scanners and other devices or sources to output devices such as printers or other destinations in modular, plug-in fashion. An operating system may expose an application programming interface or other resource to graphical and other applications, as well as printers and other output devices, which accepts custom gamut mappings for use in one or more applications or devices. The mappings may be stored in parameterized representations of transforms from a source space to a destination space, such as transforms involving color limits, compression and other variables. Unlike prior color management systems where applications might hardcode gamut mappings for specific purposes, according to the invention in one regard a generalized modular architecture permits any application, input device or output device to supply specific parameterized rendering data for desired output results.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of digital imaging, and more particularly to a platform which accepts and operates on parameterized color gamut mappings between input and output devices.

### BACKGROUND OF THE INVENTION

The field of digital imaging has long recognized the problem of color gamut mapping, or the translation of one volumetric color range for a camera, scanner or other input or capture device to the color range for a printer or other output device. Since both the input and output devices have a limited dynamic range, and those ranges rarely if ever coincide, some type of mapping must be generated to preserve the best, most accurate or most pleasing color palette when processing an image from input to output. As illustrated in FIG. 1, when viewing an image scanned at one machine over the Internet or other network at another machine, multiple gamut conversions or image reproductions, each susceptible to possible mismatches, have to occur. As one consequence, studies suggest that undesired product color may be among the most frequent reasons for online purchase returns.

Traditionally, a handful of gamut mapping techniques have been employed to try to maintain color integrity. According to one approach, the image source might be accepted in raw form—with color values unaltered after, for example, capture in the CCD of a digital camera. A user wishing to print the image on an inkjet or other printer may then dial hues up or down, manually to reach a visually satisfactory result on their particular display screen, color printer or other output device.

In another approach, a color management profile such as the format promulgated by the International Color Consortium (ICC) may be generated for specific devices. That profile may permit known sources or devices to map images or gamuts to a device-independent color space, from which a display, printer or other output device may be rendered, for example with desired preferences such as reduced saturation or enhanced color. Common graphical objects such as slide shows, pie charts or digital photographs may have generic profiles built up for them. However, profile-based systems including the ICC standard merely take mappings from a specifically defined and not general input, image or other source to a predefined printer or other output. Such systems do not permit the ready, or even possible, substitution of the transform functions, themselves.

In another alternative, some computer applications, particularly high-end graphical or video applications, have individually hard-coded a set of gamut mappings related to a given manufacturer's camera, scanner, printer, cathode ray tube or other device or source. While such solution sets may yield satisfactory results in given applications, they are not general purpose and the user may be left at the mercy of the manufacturer's supplied, non-alterable transforms even if not preferred. Other problems in color management technology exist.

### SUMMARY OF THE INVENTION

The invention overcoming these and other problems in the art relates in one regard to a system and method for a gamut mapping platform, in which the gamut transform mapping used for color correction may be separated from individual applications and device drivers, and hosted in a modular input module which may accept transform functions and related parameters from applications and other sources. In embodiments, the transform input module may reside in an operating system, and receive a computational expression which takes input values from a source gamut and maps to output values on a destination gamut. A graphical image file when received may then be processed in a gamut transform engine which encodes a transformed output for that image for display on a monitor, printer or other output device. Because the mapping from source gamut to destination gamut may be stored in intermediate logic, applications such as digital photo, video or other packages are freed from necessarily having to supply gamut transforms themselves, although application packages and other sources may supply selected transform mappings to the transform input module as desired.

### BRIEF DESCRIPTION OF THE DRAWINGS

FIG. 1 illustrates a gamut conversion process, according to existing techniques.

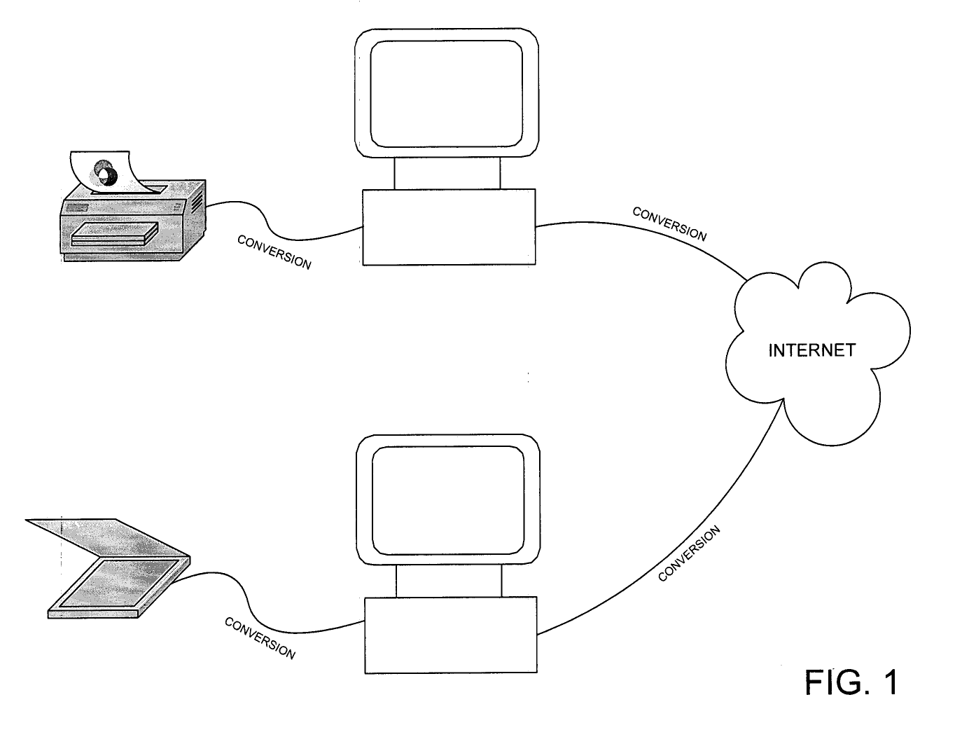

FIG. 2 illustrates a gamut mapping process, which may be incorporated in embodiments of the invention.

FIG. 3 illustrates an architecture for gamut management using a modular gamut transform, according to embodiments of the invention.

FIG. 4 illustrates overall gamut transformation processing, according to an embodiment of the invention.

### DETAILED DESCRIPTION OF EMBODIMENTS

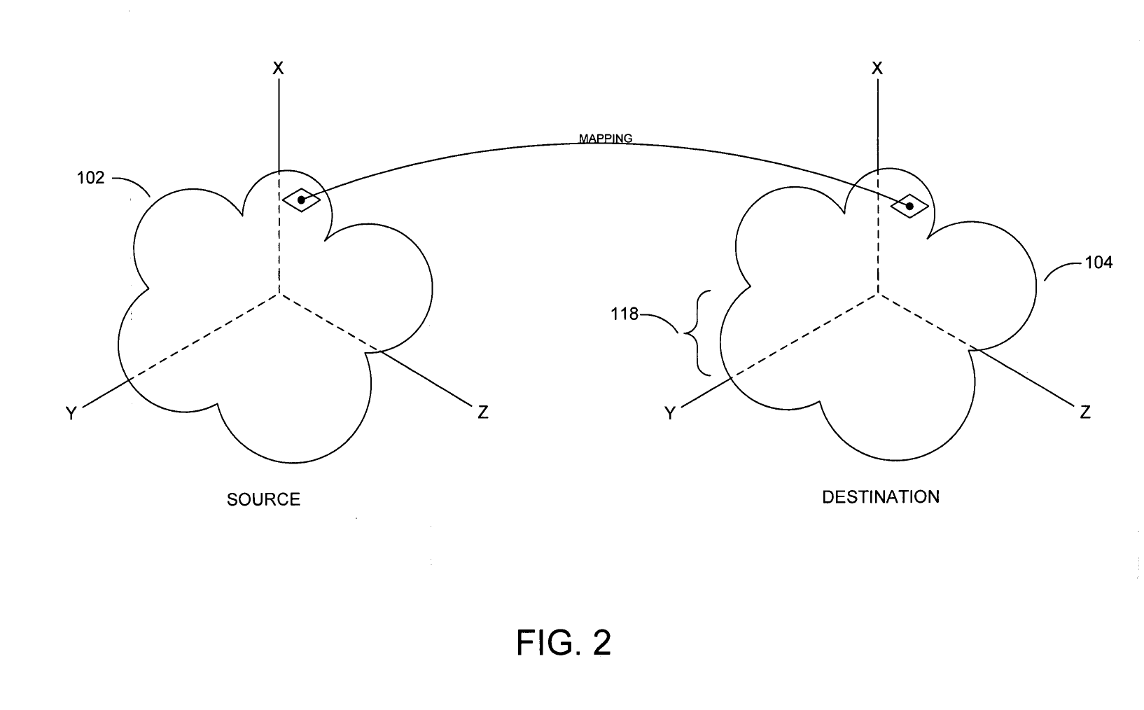

FIG. 2 illustrates an overview of source-to-destination gamut mapping which embodiments of the invention may incorporate or operate upon. As shown the process may start with a source gamut 102, representing the complete color range which a source of an image may be capable of detecting or producing. For example, the source gamut 102 may represent the range of colors which a digital camera or video camera is capable of displaying, in RGB space. Other representations, such as CMYK, may also encode the source gamut 102. In embodiments, the source gamut 102 may be stored in the form of a surface mesh of function enclosing a three-dimensional or other volumetric space consisting of the colors that the input device can capture.

Conversely, as also shown in FIG. 2 embodiments of the invention may also incorporate or operate upon a destination gamut 104, representing the color range which a monitor, printer or other output device may be capable of displaying. It may be noted that both the source gamut 102 and destination gamut 104 reflect a set of colors which is less than the absolute possible range of all mathematical color values, do to limitations in sensors such as CCDs, phosphors in monitors, inks or lasers in printers, or other electrical, mechanical or optical parts.

According to the gamut mapping platform of the invention in one regard, a mapping from source gamut 102 to destination gamut 104 may be performed or generated, to attempt to make the color content of an image which is ultimately displayed as close to the color range originally captured in the input device, or in the imaged object itself. The mapping or transform may consist of a mathematical equation or set of expressions which take points in the color space of the source gamut 102 and map them to points in the color space of destination 104. In embodiments, that mapping may or may not be one-to-one depending on device characteristics and regions of the gamut in which the transform is operating.

The gamut transform may in cases include an exponential, algebraic or other function which derives a new set of color coordinates from the source gamut 102 to arrive at the closest or approximately similar hue in the color space of destination gamut 104. In embodiments, the gamut transform may parameterize parts of that mapping expression, so that, for instance, the value of an exponent may be adjusted to cause greater or lesser alteration of the color data. It may likewise be noted that the gamut transform may consist of more than one mathematical expression, depending on factors such as the color region in which the source data point is being taken. Once the gamut transform from the source gamut 102 to the destination gamut 104 is established, a subject image file, such as a digital photograph or other graphical object or media, may be processed according to that transform to conform the displayed, printed or other output as closely as possible to the original source.

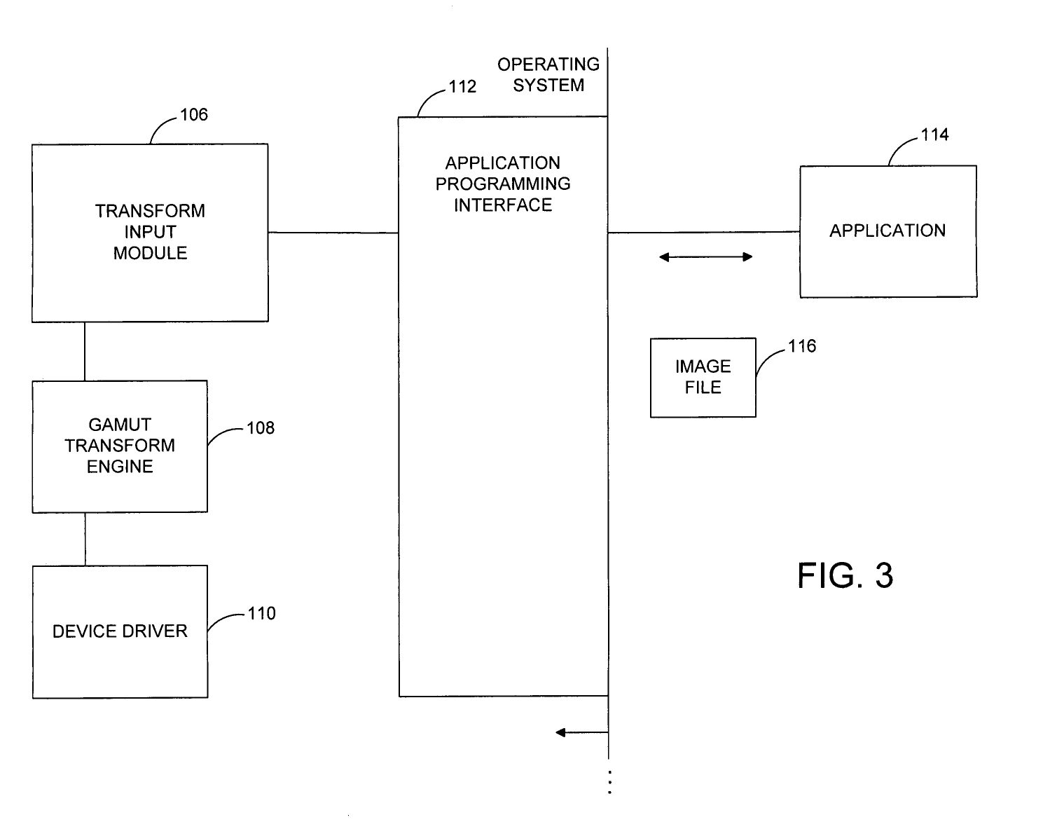

According to embodiments of the invention in another regard, the gamut mapping or transform logic which is applied to source images may be separated from application programs or other “hardwired” sources, and be configured in a modular platform permitting parameterized transform functions to be substituted in and out of the transform engine before processing. As illustrated in FIG. 3, according to embodiments of the invention the gamut transform platform may include a set of resources including a transform input module 106 and gamut transform engine 108 to support that modularity. In embodiments as shown, the transform input module 106 and gamut transform engine 108 may both reside within an operating system, such as the Microsoft Windows™ family of operating systems or others, and expose gamut transformation services to one or more application 114 through an application programming interface 112. In operation as shown, the transform input module 106 may receive a gamut transform to drive the gamut matching of an image file 116, which may be or include, for instance, digital photographs, video clips or other media or content, in JPG, GIF, Windows Media, Real™ video or other formats or files for display, printing or other output.

The transform input module 106 may receive the gamut mapping from the application 114 itself, or from a user-selected or other source. For example, the manufacturer of a printer or other output device may assemble a transform or library of transforms to be accessed by or incorporated in the operating system or other supporting platform for the transform engine. In embodiments, the transform input module 106 may contain or access a default gamut transform, for instance one based on perceptual intents such as the color-enhanced display of digital photographs. In embodiments, desired transform parameters may be dynamically selected by the user, for instance via an interactive graphical or other interface, for example displaying real-time adjustments, or otherwise. In other embodiments, other perceptual intents or preferences may be used, for example in a set of default transforms or otherwise.

With a gamut transform function and any necessary parameters received in transform input module 106, the gamut transform engine 108 may access that expression and operate to transform the source color data of image file 116 for output. In embodiments, the gamut transform engine 108 may, for example, traverse the mesh or other contours of the source gamut 102 and generate a set of deltas in a lookup table (LUT) indicating what color points adjust by how much to arrive at a corresponding hue in the destination gamut 104, again such as a printer or other output device. A lookup table storing translation to final destination values may also be used. Other representations or encodings of the relationship between the source gamut 102 and the destination gamut 104 under the operative gamut transform may be used.

One the gamut transform engine 108 identifies the necessary LUT or other transform encoding, the gamut transform engine 108 may apply that mapping to the color values of image file 116 to generate a transformed image file for output. For example, transformed 8 or 24-bit JPG values may be generated from the image file 116 which may to the destination gamut 104 of a target printer, monitor or other device. The transformed image file or data therefrom may be communicated to a device driver 110, which may also be resident in the operating system, for display on that monitor or other device. Because the gamut transform is abstracted and exposed to applications and other consumers in a modular, transparent manner the application need no longer hard code a gamut mapping for output or other purposes. Moreover, individual users may adjust and refine different gamut transforms for different purposes, such as mappings which provide satisfactory results for a given model or type of digital camera when images are printed to a certain manufacturer's printer. Libraries or classes of gamut transforms may be developed to be transmitted to transform input module 106, for example mappings which emulate 35 mm film by emphasizing green or other hues. Other mappings, transforms and perceptual intents are possible, which may in embodiments be interactively selectable by the user.

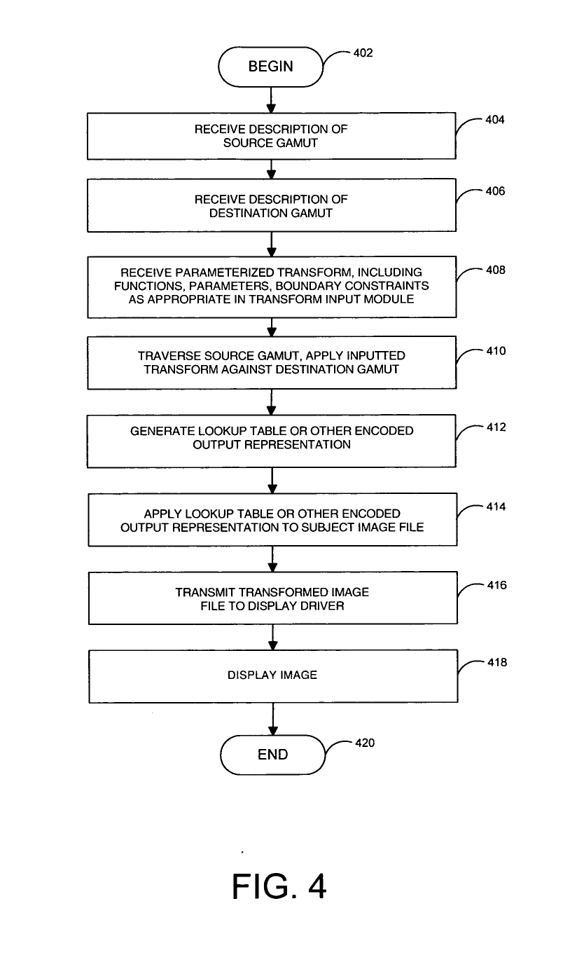

FIG. 4 illustrates overall gamut mapping processing, according to embodiments of the invention. In step 402, processing may begin. In step 404, a description of source gamut 102 may be received, for example a description of the volumetric (three dimensional) boundaries, surface or mesh of that gamut or space. In step 404, a description of the destination gamut 104 may be received, for example likewise in the form of volumetric boundaries, surface or mesh of that gamut or space. Gamuts expressed in one, two or four or more dimensional space may likewise be received.

In step 408, a parameterized gamut transform may be received in transform input module 106, for instance from an application, disk or other media, an Internet site or other source. The gamut transform may take the form, for example, of an exponential, algebraic or other function mapping color, hue, saturation, intensity or other color or image variables from source gamut 102 to destination gamut 104, or take on other forms. In embodiments parameters, such as exponent values to be used in the mapping computations, may likewise be received. In step 410, the gamut transform engine 108 may traverse the source gamut 102 and apply the modular gamut transform to that gamut to generate corresponding points on the destination gamut 104. In step 412, a lookup table of source-to-destination deltas or other encoded representation indicating the conversion from source gamut 102 to destination gamut 104 may be generated.

In step 414, the resulting lookup table or other encoded transform representation may be applied to the image file 116 or other source data to generate a transformed image file or other object. In step 416, the transformed image file may be transmitted to device driver 110, for example a video card driver, a monitor or printer driver, a digital camera driver or software, or other driver or software to generate the pixels or other information for display. In step 418, the resulting image may be displayed or output, for example on a monitor, in a color, black and white, halftone or other printed output, in a facsimile or other output or format. In step 420, processing may repeat, return to a prior processing point, jump to a further processing point or end.

The foregoing description of the invention is illustrative, and modifications in configuration and implementation will occur to persons skilled in the art. For instance, while the invention has generally been described in terms of embodiments in which a single gamut transform engine 108 within an operating system generates output transformations, in embodiments multiple transform engines or modules within or outside an operating system may perform the same logic and computation.

Similarly, while the invention has in embodiments been described as operating on an image file 116, in embodiments and usage different types of source objects or files may be processed and transformed, such as textual, mixed text and graphics, video sample or other visual information. Other hardware, software or other resources described as singular may in embodiments be distributed, and similarly in embodiments resources described as distributed may be combined. Further, while the invention has generally been described as applying a single gamut mapping supplied by one application 114, in embodiments more than one gamut mapping, or a series of consecutive mappings may be supplied by multiple applications and other sources, and applied to the image file 116 or other source object. The scope of the invention is accordingly intended to be limited only by the following claims.

1. A system for managing the gamut transformation of a graphical image, comprising:
a transform input module to receive a modular gamut transform;
a gamut transform engine, the gamut transform engine communicating with the transform input module to receive the modular gamut transform and transform a graphical image thereby; and
an interface to a device driver, the gamut transform engine transmitting the transformed graphical image to the device driver to output the transformed graphical image.

2. A system according to claim 1, wherein at least one of the transform input module and the gamut transform engine reside in an operating system.

3. A system according to claim 1, wherein the modular gamut transform comprises at least one of a gamut transform function, gamut range mapping data, gamut constraint data and gamut transform function parameters.

4. A system according to claim 3, wherein the modular gamut transform comprises at least one of a compression function and a decompression function.

5. A system according to claim 1, wherein the transformation of the graphical image comprises generating a gamut lookup table for output on an associated output device.

6. A system according to claim 5, wherein the output device comprises a printer.

7. A system according to claim 1, wherein the modular gamut transform is supplied by an application.

8. A system according to claim 1, wherein the gamut transform engine transforms the graphical image using a default gamut transform when no modular gamut transform is supplied.

9. A system according to claim 8, wherein the default gamut transform is based on a perceptual intent.

10. A system according to claim 1, wherein the gamut transform engine traverses at least one of a source gamma mesh associated with an input device and a destination gamma mesh associated with the output device, applying the modular gamma transform thereto.

11. A system according to claim 1, wherein the graphical image comprises at least one of a graphical image data, textual data and video data.

12. A method for managing the gamut transformation of a graphical image, comprising:
receiving a modular gamut transform;
transforming a graphical image via the modular gamut transform; and
transmitting the transformed graphical image to the device driver to output the transformed graphical image.

13. A method according to claim 12, wherein at least one of the receiving and the transforming is performed in an operating system.

14. A method according to claim 12, wherein the modular gamut transform comprises at least one of a gamut transform function, gamut range mapping data, gamut constraint data and gamut transform function parameters.

15. A method according to claim 14, wherein the gamut transform function comprises at least one of a compression function and a decompression function.

16. A method according to claim 12, wherein the transforming comprises generating a gamut lookup table for output on an associated output device.

17. A method according to claim 16, wherein the output device comprises a printer.

18. A method according to claim 12, wherein the modular gamut transform is supplied by an application.

19. A method according to claim 12, wherein the transforming uses a default gamut transform when no modular gamut transform is supplied.

20. A method according to claim 19, wherein the default gamut transform is based on a default perceptual intent.

21. A method according to claim 12, wherein the transforming comprises traversing at least one of a source gamma mesh associated with an input device and a destination gamma mesh associated with the output device, applying the modular gamma transform thereto.

22. A method according to claim 12, wherein the graphical image comprises at least one of a graphical image data, textual data and video data.

23. A graphical image, the graphical image being transformed for output according to a method comprising:
receiving a modular gamut transform;
transforming a graphical image via the modular gamut transform; and
transmitting the transformed graphical image to the device driver to output the transformed graphical image.

24. A graphical image according to claim 23, wherein at least one of the receiving and the transforming is performed in an operating system.

25. A graphical image according to claim 23, wherein the modular gamut transform comprises at least one of a gamut transform function, gamut range mapping data, gamut constraint data and gamut transform function parameters.

26. A graphical image according to claim 23, wherein the output device comprises a printer.

27. A graphical according to claim 23, wherein the transforming comprises traversing at least one of a source gamma mesh associated with an input device and a destination gamma mesh associated with the output device, applying the modular gamma transform thereto.

28. A graphical image according to claim 23, wherein the graphical image comprises at least one of a graphical image data, textual data and video data.

29. A system for managing the gamut transformation of a graphical image, comprising:
transform input means to receive a modular gamut transform;
gamut transform means, the gamut transform means communicating with the transform input means to receive the modular gamut transform and transform a graphical image thereby; and
interface means to a device driver, the gamut transform means transmitting the transformed graphical image to the device driver to output the transformed graphical image.

30. A system according to claim 29, wherein the transformation of the graphical image comprises generating a gamut lookup table for output on an associated output device.

31. A system according to claim 29, wherein the output device comprises a printer.

32. A system according to claim 29, wherein the gamut transform means traverses at least one of a source gamma mesh associated with an input device and a destination gamma mesh associated with the output device, applying the modular gamma transform thereto.

33. A system according to claim 29, wherein the graphical image comprises at least one of a graphical image data, textual data and video data.
